(19) United States
(12) Patent Application Publication
(10) Pub. No.: US 2008/0004963 A1
(43) Pub. Date: Jan. 3, 2008

(54) Visual display for hand dryer

(76) Inventors: Anthony Montalbano, Oak Brook, IL (US); Randy Cordova, Aurora, IL (US); Linda Cordova, Aurora, IL (US); Thomas Glunz, Barrington, IL (US)

Correspondence Address: THE LAW OFFICE OF RANDALL T. ERICKSON, P.C., 1749 S. NAPERVILLE ROAD, SUITE 202, WHEATON, IL, 60187, US

(21) Appl. No.: 11/728,175

(22) Filed: Mar. 23, 2007

Related U.S. Application Data
(60) Provisional application No. 60/784,995, filed on Mar. 23, 2006.

(51) Int. Cl. F26B 19/00; G06Q 30/00; H04B 7/00; H04L 12/66

(52) U.S. Cl. 705/14; 34/90; 370/310; 370/355

(57) ABSTRACT

The invention provides a synergistic combination of a plurality of hand dryers, each with a programmed computer display, and all communicating to a central location via a high speed link system. A display screen is mounted to each of the hand dryers and viewable by a user while drying the user's hands. A processor is located within the housing and is in signal-communication with the display screen. The high-speed link system is in signal-communication with each processor and an external data source, wherein the data source communicates with the processor to change the image displayed on the display screen.

This application claims the benefit of U.S. Provisional Application Ser. No. 60/784,995 filed Mar. 23, 2006.

### TECHNICAL FIELD OF THE INVENTION

The invention pertains to hand dryers that include a digital display screen for conveying information, such as advertising.

### BACKGROUND OF THE INVENTION

Hand dryers which include display screens for displaying information are known. One such hand dryer includes an integrated modem that automatically updates the stored images every 24 hours. Up to 20 images are stored and displayed in sequence.

The present inventors have recognized that it would be desirable to provide a display screen for a hand dryer that was nearly instantly responsive to a centralized control to display news, information, images and advertising. The present inventors have recognized that it would be desirable to provide a display screen for a hand dryer that was easily updated and reconfigured from a remote location.

### SUMMARY OF THE INVENTION

The invention provides a synergistic combination of a plurality of hand dryers, each with a program computer display, and all communicating to a central location via a high speed link system.

According to a preferred embodiment, a hand dryer includes a housing, a fan, a heater, a display screen and a processor. The fan is located within a housing. The heater is also located within the housing, the fan drawing air past the heater to heat the air and to dispense the air from within the housing externally of the housing to dry a user's hands. The display screen is mounted to the housing and viewable by a user while drying the user's hands. The processor is located within the housing and is in signal-communication with the display screen.

A high-speed link is in signal-communication with the processor and an external data source, wherein the data source communicates with the processor to change the image displayed on the display screen.

The high-speed link can comprise a wireless receiver. The high-speed link can comprise a subscriber line. The hand dryer can comprise a hard disc drive or a compact flash memory or like device for local memory and operational storage.

The preferred system of the invention can comprise a central data source, and a plurality of powered hand dryers. Each of the hand dryers includes a display screen mounted to a front thereof and viewable by a user while drying the user's hands. Each of the hand dryers includes a display processor located therein and in signal-communication with the display screen. Each of the hand dryers includes a high-speed link in signal-communication with the display processor and the central data source.

The high speed links can comprise wireless receivers and the central data source comprises a wireless transmitter to communicate with each of the wireless receivers.

The high speed links can comprise subscriber lines and the central data source can communicate through the subscriber lines to the hand dryers.

The high-speed links can comprise Ethernet cables, and the central data source communicates through the Ethernet cables to the hand dryers.

The system can comprise a local processor and a LAN in signal-communication between the local processor and the plurality of display processors, the local processor in signal-communication with the central data source. The LAN can comprise an Ethernet system. The LAN can comprise a wireless system.

An exemplary embodiment of the invention comprises the method of entering, storing and displaying media information, comprising the steps of: entering and storing media information into an information management application, wherein media information is stored according to advertising time blocks for each display application; providing a plurality of information display applications, each located in a different location; providing an information instruction server application for communicating information from the information management application to the information display applications; and, using the information management application, determining an open time block in a particular information display application and entering a media information data associated with the time block for display at the information display application.

The information display application can comprise the step of using a LAN to communicate to a plurality of information display screens at a site.

The method can include the further step of using the information display applications, communicating operational status to the information management application through the information instruction server.

According to the invention, an Ethernet programmability feature allows internet downloading of advertising or employee training information through cable, telephone, wireless or satellite connection.

The processor within a hand dryer can have its stored information updated at any time. The processor can e-mail its operating status to a central office. A plurality of display screens can be used in a grid display. One processor in a hand dryer can be specified as a master unit for any number of slave processors.

According to an exemplary embodiment of the invention, an industrial computer with a digital LCD screen or TFT LCD color digital screen is coupled to an automatic, infrared sensing hand dryer. The computer is enclosed behind a one-piece, 16-gauge stainless steel cover. The cover includes a quarter-inch thick safety glass to protect the LCD screen. The computer can comprise a 1.5 GHz computer processor. A large or small hard drive capacity could be provided. Alternatively, flash memory or other type memory can be used. The screen can be an LCD TFT digital color screen with a display resolution of 1024×768 full-color pixels. An LVDS interface provides the ability to display 16 million colors simultaneously for image compatibility for JPEG, GIF, PNG, BMP, SWF and video formats.

The hand dryer is preferably activated by a reflected infrared sensor. A polycarbonate lens, protected with frequency match tinting, filters out ambient light. The circuitry preferably has self adjusting timeout and fail safe off protection. The circuitry is microprocessor controlled to detect and reject false signals and the circuitry shall self calibrate to provide uniform sensitivity. The dryer preferably has dual centrifugal blower wheels driven by 0.25 horsepower, dual shaft, series motor, operating at 7500 RPM. Preferably, the dual blowers deliver about 183 CFM. Dual, nickel-chromium heating elements can be provided that each delivers 1000 W to provide a 73 F. degree rise over the ambient temperature. Both heating elements and blower motor can be protected with automatic resetting thermostats.

The voltage regulation of the computer display is provided by the hand dryer voltage regulation circuitry (100-277 VAC, 50/60 Hz) thus precluding the need to provide different models for different operating voltages. One unit will be voltage compliant for the entire world market. It would take individual units of 100, 120/127, 208, 220, 240 and 277 to cover this voltage range if the automatic voltage regulation circuitry was not utilized.

Numerous other advantages and features of the present invention will be become readily apparent from the following detailed description of the invention and the embodiments thereof, and from the accompanying drawings.

### BRIEF DESCRIPTION OF THE DRAWINGS

FIG. 1 is a front view of a hand dryer according to the present invention;

FIG. 2 is a side view of the hand dryer shown in FIG. 1;

FIG. 3 is a top view of the hand dryer shown in FIG. 1;

FIG. 4 is a schematic diagram of the hand dryer shown in FIG. 1; and

FIG. 5 is a method step algorithm demonstrating the operation of the hand dryer shown in FIG. 1;

FIG. 6 is a schematic block diagram of the hand dryer according to the present invention; and

FIG. 7 is a perspective view of the hand dryer according to the present invention.

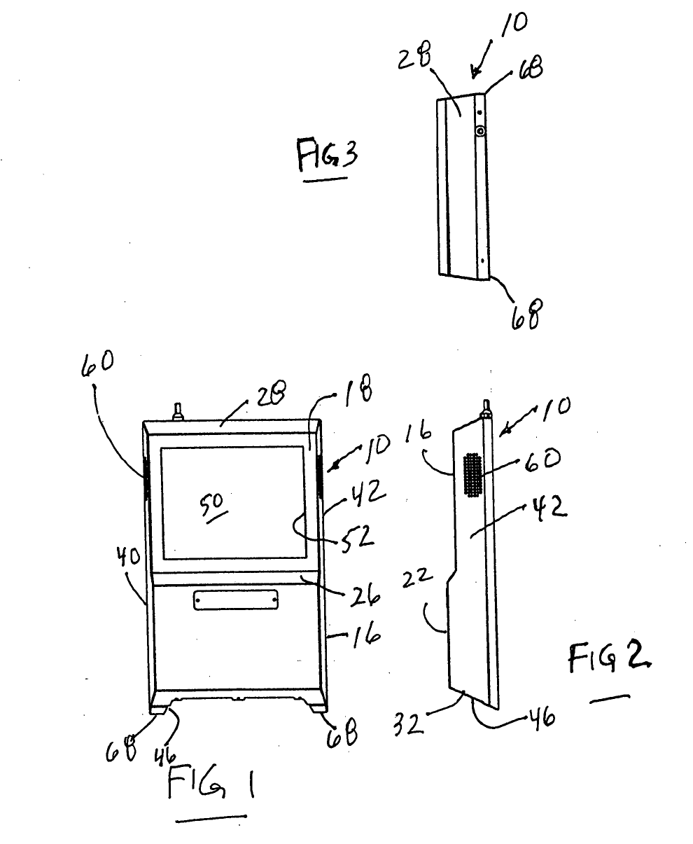

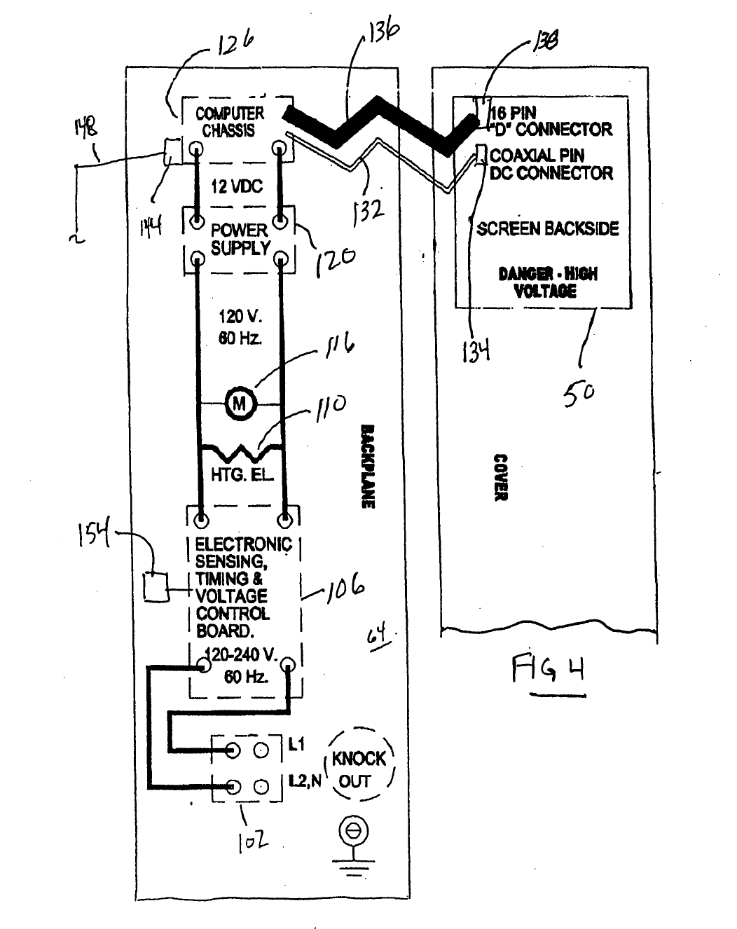

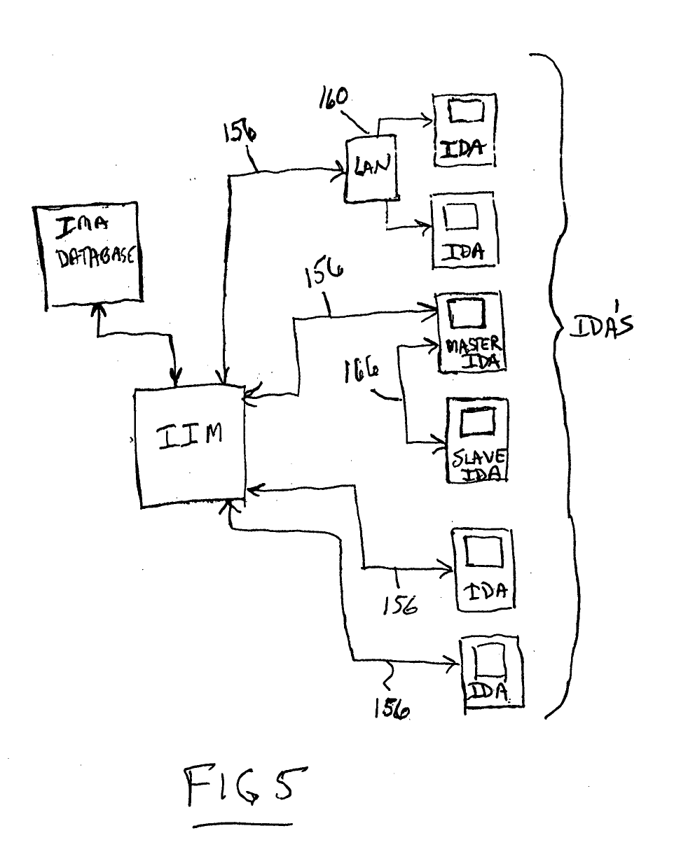

### DETAILED DESCRIPTION OF THE PREFERRED EMBODIMENTS

While this invention is susceptible of embodiment in many different forms, there are shown in the drawings, and will be described herein in detail, specific embodiments thereof with the understanding that the present disclosure is to be considered as an exemplification of the principles of the invention and is not intended to limit the invention to the specific embodiments illustrated.

FIG. 1 illustrates a hand dryer 10 that incorporates the present invention. The hand dryer includes a metallic housing 16 having an upper front wall portion 18 and a lower front wall portion 22 connected by a front wall transition 26. The front wall portions are connected to a top wall 28, a bottom wall 32, and left and right side walls 40, 42. An access panel 43 is provided to close a maintenance opening 44.

Components are included within the housing for providing a warm air discharge through an opening 46 through the bottom wall.

A display screen 50 is provided within an opening 52 through the front wall portion 18. The display screen is a digital display screen preferably having a 12.1 inch or 15 inch diagonal dimension. Preferably, the digital display screen is an LCD TFT screen. The display resolution is preferably 1024×768 with an image format compatible with JPEG, GIF, PNG, BMP, SWF and video formats. According to one exemplary embodiment, the screen is a SHARP model LQ150X1LGN2E TFT-LCD module. According to another embodiment, the screen is a NEC brand TFT Color LCD Module NL10276AC24-02. U.S. Pat. Nos. 6,611,092; 6,583,556; and 6,429,912 describe LCD screens and their construction, hereby incorporated by reference.

Air intake perforations 60 are sized to prevent access to internal parts. A back plate 64 is provided with vibration isolation mounting bushings 68.

FIG. 4 illustrates the internal components of the dryer in schematic fashion. A terminal block 102 is connected to the hot and neutral lines of a commercial or domestic power supply. The power is wired to an electronic sensing, timing and voltage control board 106. A universal switching power supply provides proper voltages and regulation to internal electronics.

For the United States voltage is stepped down by the voltage control board 106 to 120 V, 60 Hz to drive heating elements 110 and the blower motor 116. A power supply 120 converts the 120V to a regulated 12 VDC power supply to power the processor 126. The voltage control board 106 and power supply 120 can also be configured to automatically convert 110V, 50 Hz foreign country power supplies to 12 VDC. Power is connected via a power line 132 to a coaxial pin connector 134, and signals are connected via a cable 136 to a 16 pin connector 138 to a backside of the screen. Alternatively, the LCD screen is coupled to the video processing board via a shielded LVDS cable.

The processor 126 includes flash memory or a 40 GB hard drive or other type memory. The processor 126 includes an input/output 144 compatible with WiFi or Ethernet over a high-speed Internet connection 148 to a server.

According to one exemplary embodiment, the dryer portion is an ASI brand surface mounted sensor hand dryer, Model 0180, available from American Specialties, Inc. of Yonkers, N.Y., USA. U.S. Pat. Nos. 4,914,833; 5,031,337; 6,050,000; and 5,146,695 disclose constructions of wall mounted hand dryers, herein incorporated by reference. The dryer portion includes an IR sensor that activates the dryer when a user's hands are placed close to a sensor. The dryer is turned off when the hands are removed from proximity to the sensor, or turned off by a timer. The motor and heating elements have internal, resetting automatic thermostat protection. Preferably, the unit operates at 183 CFM of heated air to provide a drying time of less than 30 seconds for the user's hands. The circuitry shall have self-adjusting time-out and fail-safe off protection controlled by microprocessor to detect and reject false signals. The circuitry will automatically self-calibrate to provide uniform sensitivity over its entire life span. The infrared sensor shall be protected by a heavy-duty polycarbonate lens frequency match-tinted to filter out ambient light. The unit is internally electrically grounded. The display screen is preferably covered by quarter inch safety glass to protect the screen from impact or touching.

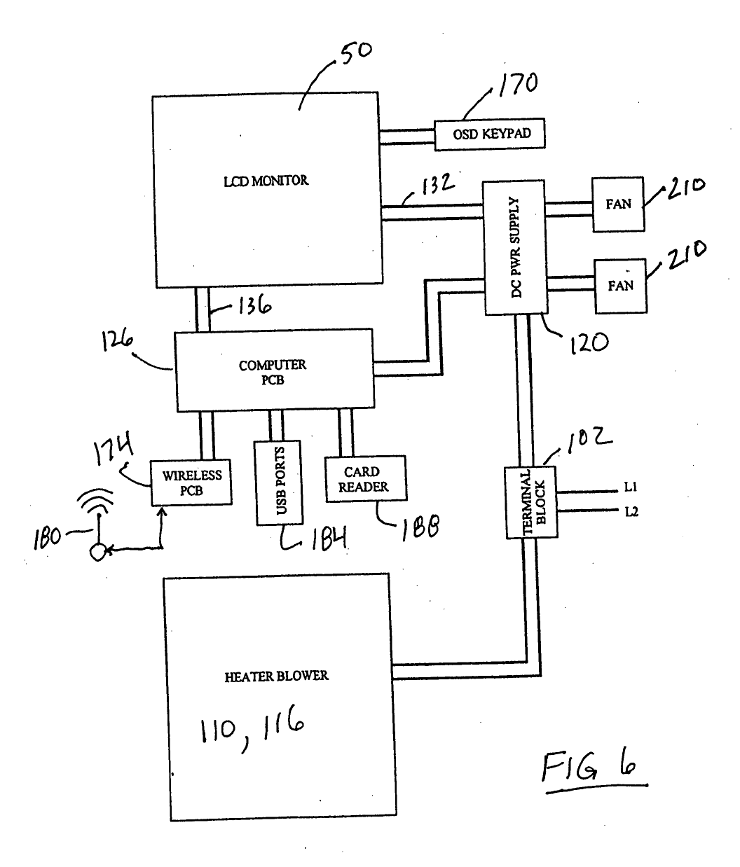

The invention provides a method of entering, storing, and displaying image and media information as illustrated in FIG. 5. The system's public interface will display images and other media content on a computer based device. The system is comprised of three individual systems or applications:

1) Information Management Application (IMA)

2) Information Display Applications (IDA)

3) Information Instruction and Media Server (IIM—Web application)

The IMA is a user interface or application and corresponding database. The IMA will be used to enter and store information about the site and location of the particular IDA, and specific to the IDA, instructions, images, and other forms of media. The images and media may be stored in either the database or in a file based system with the database store the reference information to that media. The IMA shall have the ability to communicate with the IIM server or database either via a LAN or through the Internet. The IMA will also have the ability to store marketing information related to the location and site of the IDA machines. The application or software may optionally query the IIM to determine which IDAs have available “slots” or “blocks” based on the stored marketing information for quoting and reporting purposes.

The IDA is a device to display images, information, and other media content based on the instructions provided by the IIM. The IDA can connect to the Internet directly via a link 156 (cable, wireless, or other type) or other type of network, such as a local area network (LAN) 160, or via a master/slave link 166 between IDA's for the purpose of receiving instructions from the IIM. The IDA application can provide authentication information to the IIM. Once the IDA is verified, it can request for instruction from the IIM service. Based on these instructions, the IDA can download the relevant images and media The instructions shall include image or media information and duration. This will determine how the images will display and function. The IIM service may also provide instructions concerning updates, change in schedule, and other information as deemed necessary for the IDA to function. The IDA may also provide information to the IIM concerning logging or possible failures.

The IIM is an application that is capable of connecting to the same database of information and media content, which the IMA has provided. Based on this information, the IIM will determine and create instruction for the many IDA's as they connect to the IIM service. The individual IDA machine will access the IIM through the Internet. The IDA will send an HTTP request or other unspecified type of request to the IIM web application. The web application will verify the validity of the request by matching up the authentication information along with the IDA I.P. and MAC Address against the information stored in the database. Once this is verified, the web application will query the database and determine the instructions (as described above) for that particular display unit. The IDA may pass other logging and diagnostic information which the IIM will interpret and store as needed.

A particularly useful process is set forth below.
A) The IDA sends a web request to the IIA, the IIM authenticates and logs the requesting display (IDA). Then the IIM queries the database schedule and responds with a list of images the IDA shall download from the FTP server.
B) The IDA sends a request in a pre-defined interval. The IIM can be configured to log this activity for every IDA. Reports or alerts could be generated for displays that do not send a request, or several consecutive requests, as they are programmed.
C) The software on the IDA can be configured to delete old images if they are unused and have an older file date, for example, the IDA could delete images older than 1 month old.
D) The IDA can be configured to send a request to the IIM reporting its internal software version number. If the IIM determines there is a newer version of the IDA software, it can be configured to respond with the new file name of the IDA software. The IDA downloads that update and executes it, which starts the new version of the IDA software. Once the new version is started, the old version is stopped.
E) Referring to part “B”, the process can poll or query via an external process or within the IMA software for inactive units that are declared as in production.

Referring to “E”, “External Process” refers to a separate program or software that runs all the time that constantly checks or polls the database. If this process finds a problem, it could Email a manager to notify of the situation. “In production” refers to machines that are stated to be “in use”, or not a unit sitting in storage. This can be more effective than the IMA pointing out a problem, since it could only report a problem when someone is actually using the program.

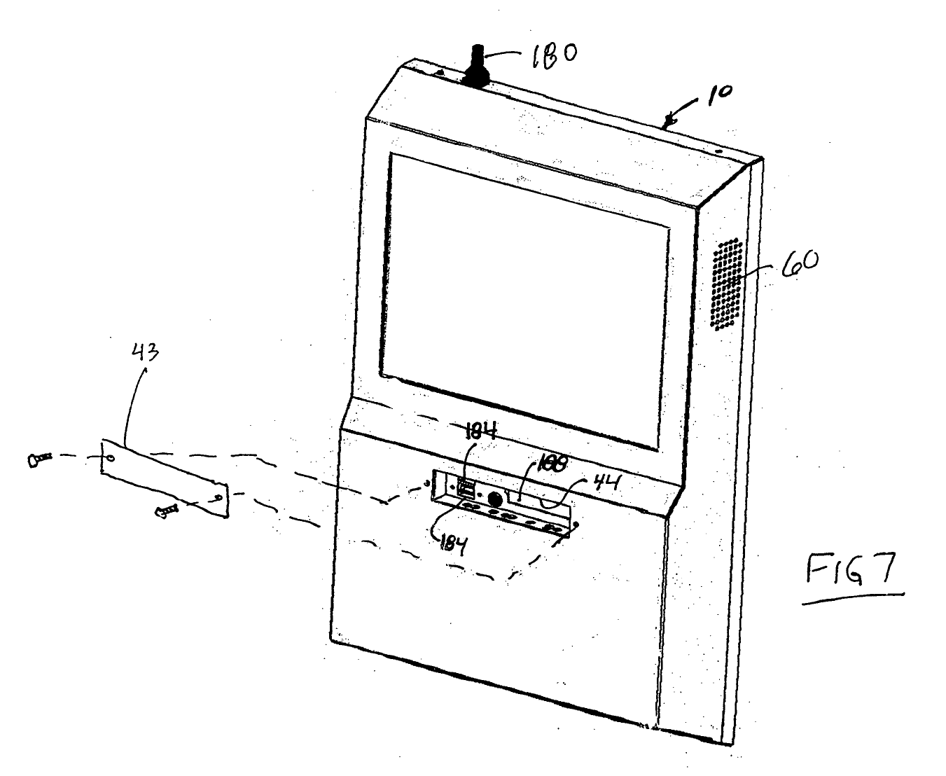

FIGS. 6 and 7 illustrate and describe an exemplary embodiment hand dryer according to the invention. The screen 50 is powered by the DC power supply 120. The screen 50 is signal-connected to the on-board computer 126 by the cable 136. The screen 50 is configured to support an on screen display keypad 170. The on board computer 126 includes a wireless circuit board 174 that is signal connected to an antenna 180 that is mounted to a top of the cabinet. USB ports 184 and a flash card reader 188 are provided within the access opening 44 behind the cover 43.

The USB ports 184 and the card reader 188 allow the dryer 10 to be programmed and/or to receive data files by a local technician even if no remote communication is available to the dryer 10.

One or more computer cooling fans 210 are provided to maintain the screen 50 and computer 126 at an acceptable operating temperature.

From the foregoing, it will be observed that numerous variations and modifications may be effected without departing from the spirit and scope of the invention. It is to be understood that no limitation with respect to the specific apparatus illustrated herein is intended or should be inferred.

The invention claimed is:

1. A hand dryer, comprising:
a housing;
a fan located within said housing;
a heater located within said housing, said fan drawing air past said heater to heat said air and to dispense said air from within said housing externally of said housing to dry a user's hands;
a display screen mounted to said housing and viewable by a user while drying hands of the user;
an on board computer system located within said housing and in signal-communication with said display screen;
a high-speed link in signal-communication with said computer system and an external data source;
wherein said data source communicates with said computer system to change the image displayed on said display screen.

2. The hand recording to claim 1, wherein said high-speed link comprises a wireless receiver.

3. The hand dryer according to claim 1, wherein said high-speed link comprises a subscriber line.

4. The hand dryer according to claim 1, wherein said on board computer comprises a compact flash memory.

5. A communications system comprising:
a central data source;
a plurality of powered hand dryers, each of said hand dryers including a display screen mounted to a front thereof and viewable by a user while drying hands of the user;
each of said hand dryers including a display processor located therein and in signal-communication with said display screen; and
each of said hand dryers including a high-speed link in signal-communication with said display processor and said central data source.

6. The communications system according to claim 5, wherein said high speed links comprise wireless receivers and said central data source comprises a wireless transmitter to communicate with each of said wireless receiver's.

7. The communications system according to claim 5, wherein said high speed links comprise subscriber lines and said central data source communicates through said subscriber lines to said hand dryers.

8. The communications system according to claim 5, wherein said high-speed links comprise Ethernet cables, and said central data source communicates through said Ethernet cables to said hand dryers.

9. The communications system according to claim 5, comprising a local processor and a LAN in signal-communication between the local processor and the plurality of display processors, said local processor in signal-communication with said central data source.

10. The communications system according to claim 9 wherein said LAN comprises an Ethernet system.

11. The communications system according to claim 9, wherein said LAN comprises a wireless system.

12. A method of entering, storing and displaying media information, comprising the steps of:
entering and storing media information into an information management application, wherein media information is stored according to advertising time blocks for each display application;
providing a plurality of information display applications, each located in a different location;
providing an information instruction server application for communicating information from said information management application to said information display applications;
using said information management application, determining an open time block in a particular information display application and entering a media information data associated with the time block for display at said information display application.

13. The method according to claim 13, wherein said information display application comprises the step of using a LAN to communicate to a plurality of information display applications at a site.

14. The method according to claim 13, comprising the further step of using said information display applications, communicating operational status to said information management application through said information instruction server.
